(19) United States
(12) Patent Application Publication
(10) Pub. No.: US 2024/0081413 A1
(43) Pub. Date: Mar. 14, 2024

(54) Heating Apparatus for an Aerosol Generating Device

(71) Applicant: JT International SA, Geneva (CH)

(72) Inventor: Herman Hijma, Zwolle (NL)

(73) Assignee: JT International SA, Geneva (CH)

(21) Appl. No.: 18/274,319

(22) PCT Filed: Jan. 26, 2022
(86) PCT No.: PCT/EP2022/051791

§ 371 Date: Jul. 26, 2023

(30) Foreign Application Priority Data
Feb. 2, 2021 (EP) 21154758.3

(51) Int. Cl. A24F 40/465; A24F 40/20

(52) U.S. Cl. CPC A24F 40/465; A24F 40/20

(57) ABSTRACT

A heating apparatus for an aerosol generating device includes a heating chamber configured to receive an aerosol forming substrate; and a first susceptor provided at a periphery of the heating chamber configured to provide heating by magnetic induction. The first susceptor includes a first body having a longitudinal axis; and a first plurality of projections which extend from the first body at a plurality of spaced positions along the longitudinal axis to form spaces between adjacent projections. In this regard, the surface area of the first susceptor is increased such that the first susceptor may be more efficient at converting electromagnetic energy to energy used to heat an aerosol generating substrate.

### FIELD OF INVENTION

The present disclosure relates generally to an aerosol generating device. In particular, the invention relates to an aerosol generating device with an inductive heating apparatus.

### BACKGROUND TO THE INVENTION

There is a demand for more efficient aerosol generating devices which can operate for longer periods between successive battery charges, or can be provided with cheaper or lighter batteries. There is also a demand for aerosol generating devices which are simple to manufacture. It is an object of the present invention to address these demands.

### SUMMARY OF INVENTION

According to an aspect of the invention, there is provided a heating apparatus for an aerosol generating device, comprising: a heating chamber configured to receive an aerosol forming substrate; and a first susceptor configured to provide heating by magnetic induction provided at a periphery of the heating chamber; wherein the first susceptor comprises: a first body having a longitudinal axis; and a first plurality of projections which extend from the first body at a plurality of spaced positions along the longitudinal axis to form spaces between adjacent projections.

In this way, the surface area or volume of the first susceptor is increased by the provision of the first plurality of projections. Thus, the first susceptor may interact more strongly with an external time-varying electromagnetic field to provide a greater amount of heating for a given strength of electromagnetic field. In other words, the first susceptor may be more efficient at converting electromagnetic energy to heat energy used to heat an aerosol generating substrate. Where the electromagnetic field is provided by an aerosol generating device, this can increase the energy efficiency of the aerosol generating device. Additionally, providing the susceptor at a periphery of the heating chamber can enable compatibility with a heat-not-burn aerosol generating device, which typically uses tobacco rods as an aerosol generating substrate. Providing the first susceptor at a periphery of the heating chamber helps to prevent obstruction of a rod inserted into the heating chamber. The first body may have a substantially flat shape. In other embodiments, the first body may have a substantially cylindrical shape elongate in the longitudinal direction with a circumference extending towards a central axis of the heating chamber. The first plurality of projections may extend from the first body perpendicularly to the longitudinal axis, or alternatively in a direction with a non-zero component along the longitudinal axis. The first plurality of projections may comprise a substantially flat structure. In other embodiments, the first plurality of projections may comprise a three dimensional structure with a cylindrical, square, polygonal, or irregular cross section, or combination thereof in which some of the first plurality of projections have different cross sections from others. The cross sectional shape of the first plurality of projections may be chosen to maximise the magnetic interaction with a magnetic induction coil. It is envisaged that the heating apparatus may be configured for compatibility with other types of aerosol generating device which utilise, for example, a liquid substrate in a consumable cartridge.

Preferably, the heating apparatus comprises a second susceptor configured to provide heating by magnetic induction comprising a second body having the same longitudinal axis and a second plurality of projections which extend from the second body at a plurality of spaced positions along the longitudinal axis to form spaces between adjacent projections, wherein the first susceptor and the second susceptor are provided at spaced positions about a periphery of the heating chamber. In this way, more even heating may be applied to an aerosol generating substrate provided within the heating chamber. Providing an additional second susceptor further improves the area or volume of interacting susceptor material, which further increases the efficiency of the aerosol generating device. In some embodiments, the heating apparatus may comprise additional susceptors, for example three, four, five or more susceptors positioned at circumferentially spaced positions around the heating chamber. In an alternative embodiment, the additional susceptors may also be spaced longitudinally along the heating chamber. In one example, the first and second susceptors may be positioned in circumferentially spaced positions around the heating chamber in a substantially square, circular or hexagonal arrangement. It is envisaged that other polygonal arrangements may also be implemented.

Preferably, the second susceptor is positioned relative to the first susceptor such that the projections of the second susceptor interpose between the projections of the first susceptor. In this way, the space inside the heating chamber can be used effectively. In some configurations, interposing the projections can increase the strength of interaction between a magnetic field produced by an induction coil and the susceptors.

In some embodiments, the first plurality of projections are provided at a first radial distance from a central longitudinal axis of the heating chamber and the second plurality of projections are provided at a second radial distance from the central longitudinal axis of the heating chamber which is different to the first radial distance. In this way, some of the projections can be provided closer to an induction coil, which may increase the strength of interaction between the induction coil and the corresponding susceptor.

In some embodiments, the first plurality of projections are provided at a first radial distance from a central longitudinal axis of the heating chamber and the second plurality of projections are provided at a second radial distance from the central longitudinal axis of the heating chamber which is equal to the first radial distance. In this way, a heating apparatus can be provided which may be simpler to manufacture due to the symmetry of the heating apparatus.

Preferably, the first plurality of projections and/or the second plurality of projections extend from the first body and the second body, respectively, circumferentially around the heating chamber. In this way, the first susceptor and/or the second susceptor can be provided with larger surface areas or volumes without obstructing any consumables which may require insertion into the heating chamber. This configuration utilises the space within the heating chamber effectively while maintaining compatibility with a heat-not-burn aerosol generating device, which typically utilises rod-shaped tobacco sticks. In some embodiments, it is envisaged that the first plurality of projections and/or the second plurality of projections may be provided in circumferential alignment with a heating chamber but not an induction coil. This may be the case when the induction coil is not provided surrounding or wrapped around the heating chamber. In one example, the first plurality of projections may extend to around half of the circumference of the heating chamber. In other examples, they may extend by more or less than half of the circumference, such as a quarter or a third of the circumference.

Preferably, the heating apparatus further comprises a magnetic induction coil of an electromagnetic field generator configured to inductively heat the first susceptor and/or the second susceptor, wherein the magnetic induction coil is provided at least partially surrounding the heating chamber, and wherein the first and/or the second plurality of projections extend from the first body and/or the second body, respectively, to align circumferentially with the magnetic induction coil. In this way, an efficient and compact heating apparatus is provided which maximises the efficiency of electromagnetic energy to heat energy conversion by virtue of the aligned induction coil and first plurality of projections. Circumferential alignment with the induction coil in this way may provide the most efficient orientation for the first or second plurality of projections. Providing the induction coil partially surrounding the heating chamber allows for a more compact design. Preferably, the induction coil is wrapped helically around the heating chamber to reduce the distance between the susceptors and the induction coil. This can increase the amount of heat generated by the first or second susceptors by magnetic interaction with the induction coil. Preferably, the induction coil is wrapped around a full length of the heating chamber to increase the strength and uniformity of the magnetic field produced within the heating chamber.

In some embodiments, the first plurality of projections and/or the second plurality of projections are provided with a spatial frequency which matches the spatial frequency along the longitudinal axis of wire loops of the magnetic induction coil. This can further increase the degree of interaction between the first and/or second susceptors and the induction coil to further increase the efficiency of the heating apparatus. In other embodiments, it may be advantageous not to provide the first and/or second plurality of projections with a matching spatial frequency. This may depend on, for example, the geometries of the implementation and the relative positioning of the induction coil and the first and/or second susceptors.

In some embodiments, the first and/or the second plurality of projections are aligned with successive wire loops of the magnetic induction coil. This can further increase the degree of interaction between the first and/or second susceptors and the induction coil to further increase the efficiency of the heating apparatus. Alignment can be achieved by providing identically shaped susceptors longitudinally offset along the longitudinal axis of the heating chamber. Alternatively, the first and/or second susceptors can be provided at the same longitudinal position but with their respective projections longitudinally offset along the respective bodies of the first and/or second susceptors. In other embodiments, it may be advantageous not to provide the first and/or second plurality of projections aligned with the induction coil. This may depend on, for example, the geometries of the implementation and the relative positioning of the induction coil and the first and/or second susceptors.

Preferably, the heating chamber, the first body, and/or the second body are elongate along the longitudinal axis. In this way, the heating chamber, the first susceptor and/or the second susceptor have an optimal dimension for receiving or contacting with, respectively, a rod-shaped aerosol generating consumable. Providing an increased contact surface between the susceptors and a consumable is desirable because it increases the efficiency of heat transfer from the susceptor to the consumable by conduction. Thus, less energy may be required to heat the consumable to a required temperature.

In some embodiments, the first susceptor comprises a third body which is connected to the first body by the first plurality of projections, wherein the first plurality of projections extend from the third body at a plurality of spaced positions along the longitudinal axis to form spaces between adjacent projections. In this way, an alternatively shaped first susceptor can be provided which may be more efficient at heating a consumable, in certain configurations. Additionally, providing the first susceptor with a third body can allow a single susceptor to contact with a consumable along more than one surface. This may enable homogeneous heating of an aerosol generating consumable while reducing the number of susceptors necessary to achieve homogenous heating. In turn, this can make the heating apparatus simpler to manufacture. Preferably, the third body is elongate along the longitudinal axis. In some embodiments, the first susceptor may comprise additional bodies, i.e. three or four additional bodies, which may also be elongate and connected to the first body by the first plurality of projections.

In some embodiments, the heating chamber comprises walls which form a tubular structure with a plurality of flat internal side faces. The plurality of flat internal side faces can be configured to, in use, enable a consumable comprising an aerosol generating substrate to be held in place by friction between the flat internal side faces. In this way, the heating chamber can also function as a mechanism for holding the consumable in place. This avoids the need for some additional mechanism configured to hold the consumable in place. In some embodiments, the heating chamber may comprise one or more internally tapered portions configured to guide a consumable from an opening towards the flat internal side faces. The flat internal side faces may partially form a heating chamber with a substantially square or hexagonal cross section. In other embodiments, the flat internal side faces may partially or wholly form a triangular or polygonal cross section. Alternatively, the heating chamber may comprise a single curved face with a substantially circular or elliptical cross section.

In some embodiments, the first body and the first plurality of projections have a shape and a position within the heating chamber in alignment with the flat internal side faces of the heating chamber. This can enable the consumable to be held in place within the heating chamber by friction with the first body. In this way, the first susceptor can, in conjunction with the heating chamber, function as a mechanism for holding the consumable in place. At the same time, the first susceptor can utilise the friction contact as a surface to provide conductive heating to the consumable. This provides an efficient and compact heating apparatus.

In some embodiments, the aligned shape of the first body and the first plurality of projections enables the first susceptor to couple to the flat internal side faces of the heating chamber. In this way, the assembly of the heating apparatus may be simplified by reducing the number of components required to assemble the heating chamber and the first susceptor. Where more than one susceptor is provided, the additional susceptors may also be provided in this way to couple with the heating chamber. In one example, the coupling may be a friction fit coupling where the first body is sized with respect to a flat internal side wall of the heating chamber to enable a frictional coupling with the internal side wall. In another example, the spaces between the first plurality of projections may be used to mount or couple the first susceptor to the heating chamber. In this latter example, the heating chamber may comprise ribs or nodes on an internal surface, sized with respect to the first plurality of projections to enable a mechanical coupling with the first susceptor.

Preferably, a wall of the heating chamber comprises a window configured to reduce the surface area of the wall in contact with a susceptor to reduce the transfer of heat from the susceptor to the wall. In this way, less heat may be applied to the heating chamber by the first susceptor, thereby increasing the lifespan of the heating chamber and reducing the amount of undesirable particulate matter reaching the aerosol as a result of heating the heating chamber.

In some embodiments, the heating apparatus comprises a handle attached to the first susceptor configured to enable a user to remove the first susceptor from the heating chamber. In this way, the first susceptor can be removed from the heating chamber to allow for easy cleaning of the heating chamber. Consequently, the quality of the aerosol can be maintained over time. Where additional susceptors are provided, the additional susceptors may also be provided attached to the handle for removal from the heating chamber.

In some embodiments, the first plurality of projections extend from the first body along a substantially helical contour, or direction. This can maximise the alignment with an induction coil to provide a more efficient heating apparatus.

Preferably, the first body is provided at least partially within an interior volume of the heating chamber and positioned to enable the first body to, in use, hold a consumable comprising an aerosol generating substrate in place by friction. Providing the first body at least partially within the heating chamber enables the first body heat the consumable by conduction while at the same time securing the consumable in place. It may be preferable to provide the first body entirely within the heating chamber to maximise the amount of heat transferred from the susceptor to the consumable. It is envisaged that in other embodiments, the first susceptor may not be provided within the heating chamber, in which case the first susceptor may be configured to indirectly heat the consumable via intermediary components, or by convection and/or radiation.

In some embodiments, the first body comprises a raised portion which extends into the internal volume of the heating chamber to exert, in use, a pressure on the consumable held in place by the first body. The first body may comprise a cylindrical structure elongate along the longitudinal direction. Thus, the circumference of the longitudinal first body may extend into the heating chamber. In this way, the surface area in contact between the first body and the consumable may be increased. This configuration may also provide a better friction fit more effective at securing the consumable in place.

In some embodiments, the first susceptor and/or the second susceptor may be manufactured by a casting method. In this way, an irregularly shaped susceptors can be produced with greater ease.

### BRIEF DESCRIPTION OF THE DRAWINGS

Embodiments of the invention are now described, by way of example, with reference to the drawings, in which:

FIG. 1 is a cross-sectional schematic diagram of an aerosol generating device and heating apparatus in a first configuration in a first embodiment of the invention;

FIG. 2 is a cross-sectional schematic diagram of an aerosol generating device and heating apparatus in a second configuration in a first embodiment of the invention;

FIG. 3 is a perspective view of a heating chamber and susceptors in a first embodiment of the invention;

FIG. 4 is a head-on view of a heating apparatus in use in a first embodiment of the invention;

FIG. 5 is a perspective view of a susceptor in a first embodiment of the invention;

FIG. 6 is a perspective view of a heating apparatus in use in a first embodiment of the invention;

FIG. 7A is a side view of alignment between susceptors and an induction coil in a first embodiment of the invention;

FIG. 7B is a side view of alignment between susceptors and an induction coil in a first embodiment of the invention;

FIG. 8 is a perspective view of a susceptor in a second embodiment of the invention;

FIG. 9 is a perspective view of an arrangement of susceptors in a second embodiment of the invention;

FIG. 10 is a perspective view of a heating chamber and susceptors in a second embodiment of the invention;

FIG. 11 is a perspective view of a heating chamber and susceptors in use in a second embodiment of the invention;

FIG. 12 is a head-on view of susceptors in use in a second embodiment of the invention;

FIG. 13 is a perspective view of an arrangement of susceptors in an alternative configuration in a second embodiment of the invention;

FIG. 14 is a perspective view of an arrangement of susceptors in an alternative configuration in a second embodiment of the invention;

FIG. 15 is a perspective view of an arrangement of susceptors in an alternative configuration in use in a second embodiment of the invention;

FIG. 16 is a perspective view of a susceptor in a third embodiment of the invention;

FIG. 17 is a perspective view of an arrangement of susceptors in a third embodiment of the invention;

FIG. 18 is a perspective view of an arrangement of susceptors in use in a third embodiment of the invention;

FIG. 19 is a side view of a heating chamber and susceptors in a third embodiment of the invention;

FIG. 20 is a perspective view of susceptors and a handle in a fourth embodiment of the invention;

FIG. 21 is a perspective view of susceptors and a handle in a fifth embodiment of the invention;

FIG. 22 is a perspective view of susceptors and a handle in a sixth embodiment of the invention;

FIG. 23 is a top view of susceptors in a sixth embodiment of the invention;

FIG. 24 is a perspective view of susceptors in an alternative configuration in a sixth embodiment of the invention;

FIG. 25 is a perspective view of susceptors in a seventh embodiment of the invention;

FIG. 26 is a side view of susceptors in an eighth embodiment of the invention;

FIG. 27 is a perspective view of susceptors in an eighth embodiment of the invention;

FIG. 28 is a top view of susceptors in an eighth embodiment of the invention;

FIG. 29 is a perspective view of a susceptor and a handle in a ninth embodiment of the invention; and

FIG. 30 is a perspective view of the alignment of a susceptor with an induction coil in a ninth embodiment of the invention.

### DETAILED DESCRIPTION OF THE DRAWINGS

Embodiments of the present disclosure will now be described by way of example only and with reference to the accompanying drawings.

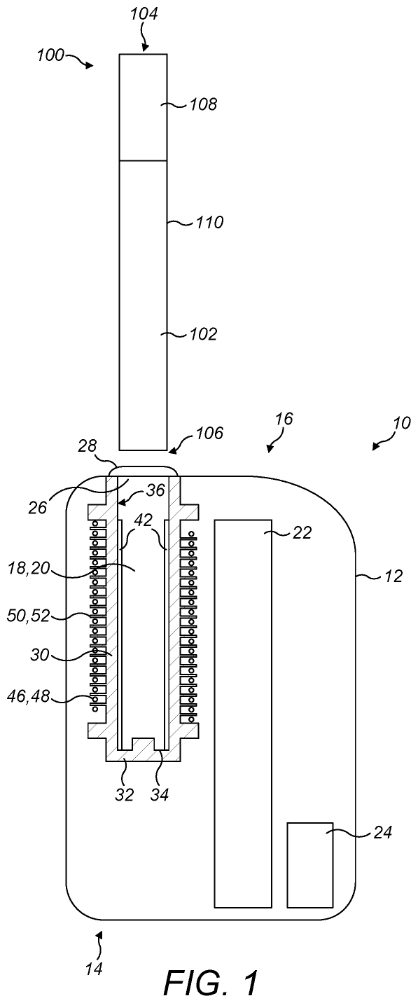

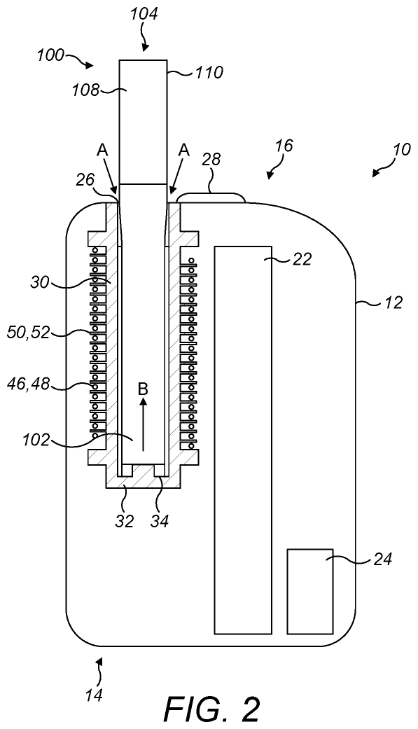

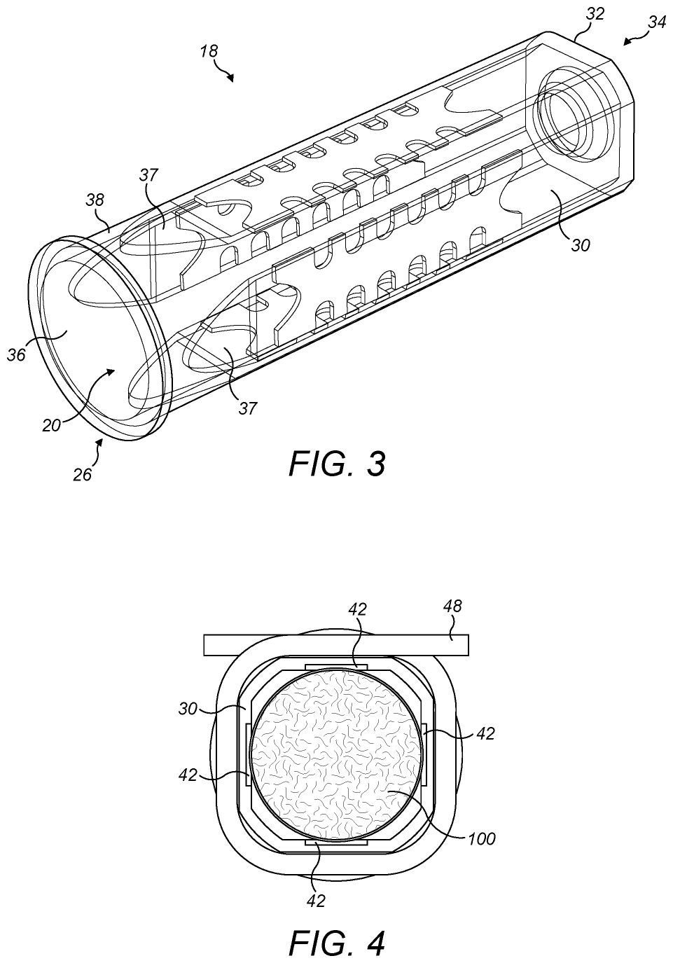

FIGS. 1 and 2 show an example aerosol generating device incorporating a first heating apparatus, as shown in FIGS. 3 to 6, according to a first example embodiment of the invention.

Referring initially to FIGS. 1 and 2, there is shown diagrammatically an example of an aerosol generating system. The aerosol generating system comprises an aerosol generating device 10 and an aerosol generating article 100 for use with the device 10. The aerosol generating device 10 comprises a main housing 12 housing various components of the aerosol generating device 10 which includes an opening to a cavity 20 formed within a heating chamber 18. An optional sliding cover 28 is provided to open or close the heating chamber 18. A plurality of inductively heatable susceptors 42 are provided within the heating chamber 18 and are configured to provide inductive heating to an aerosol generating article 100 positioned within the cavity 20. An electromagnetic field generator 46 is provided for generating an electromagnetic field used to inductively heat the susceptors 42. The electromagnetic field generator comprises a substantially helical magnetic induction coil 48 wrapped around the outer surface 38 of the heating chamber 18. In the example embodiment of FIG. 1, an optional coil support structure 50 is provided at the outer surface 38 of the heating chamber 18 and comprises a substantially helical coil support groove 52 for supporting the induction coil 48. The aerosol generating device 10 further comprises a power source 22, for example one or more batteries which may be rechargeable, and a controller 24. Additionally, the aerosol generating device 10 includes an input device, such as a button (not shown), configured to receive a user input for initiating the aerosol generation process and to forward the input to the controller 24. In some embodiments, the aerosol generating device 10 includes a temperature sensor (not shown).

The main housing 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main housing 12. The heating chamber 18 defines an interior volume in the form of a cavity 20 having a substantially cylindrical cross-section for receiving an aerosol generating article 100. The heating chamber 18 has a longitudinal axis, defining a longitudinal direction, along which the heating chamber 18 is elongate. The heating chamber 18 may be formed of a heat-resistant plastics material, such as polyether ether ketone (PEEK). In alternative embodiments, the heating chamber 18 may comprise other heat resistant materials, such as heat resistant glass or other heat resistant polymer materials.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main housing 12 to minimise heat transfer to the main housing 12.

The aerosol generating device 10 can optionally include a sliding cover 28 movable transversely between a closed position (see FIG. 1) in which it covers the open first end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the centre hole segment to form an aerosol with suitable characteristics for inhalation by a user through the filter segment.

FIG. 3 shows a perspective side view of the heating chamber 18. FIG. 4 shows a cross sectional view of the heating chamber 18 with an aerosol forming article 100 placed within the cavity 20 and with the induction coil 48 wrapped around the heating chamber 18. The heating chamber 18 has a side wall (or chamber wall) 30 extending between a base 32, located at a second end 34 of the heating chamber 18, and the open first end 26. The side wall 30 and the base 32 are connected to each another and can be integrally formed as a single piece. The side wall 30 is tubular and generally cylindrical with a polygonal cross section comprising four main flat faces connected by four bevelled corner faces to form a substantially square cross section.

The side wall 30 of the heating chamber 18 has an inner surface 36 and an outer surface 38. The inner surface 36 comprises a plurality of flat internal side faces which form the substantially square cross section. This enables a rod-shaped aerosol generating article 100 to be held between and compressed by the four main flat internal side faces, leaving air gaps towards the four corners of the heating chamber 18, as shown in FIG. 4. Thus, the aerosol generating article can be held in place by friction within the cavity 20.

Similarly, the outer surface 38 comprises a plurality of external flat side faces which also form a substantially square cross section. The induction coil 48 is provided wrapped around the outer surface 38 of the heating chamber 18. Therefore, the cross section of the induction coil 48 substantially or totally matches the cross section of the heating chamber 18. In other words, the side wall 30 and the induction coil 48 are substantially parallel.

The side wall 30 comprises four tapered portions 37 provided towards the opening of the cavity 20 which transform and narrow the cross section of the side wall 30 from a circular cross section near the open end 26 to the substantially square cross section towards the closed end 34. The substantially square cross section is slightly narrower in diameter than the circular cross section to allow a consumable to be held and compressed between the flat internal side faces. The circular cross section near the open first end 26 is slightly broader in diameter to enable easy insertion of a consumable into the heating chamber 18. The tapered portions 37 aid the insertion of an aerosol generating article 100 into the cavity 20 by a user by guiding the edges of the aerosol generating article 100 towards the four main flat internal side faces. This avoids the aerosol generating article 100 becoming snagged on a sharp corner. In the perspective view of FIG. 3, for clarity only the top and rightmost tapered portions 37 are labelled.

In some embodiments, a plurality of susceptor mounts may be formed in the inner surface 36 for securing in place the plurality of susceptors 42, and may be circumferentially spaced around the inner surface 36. In other embodiments, susceptor mounts may not be provided. Instead, the plurality of susceptors 42 may have a width closely corresponding to a width of the internal flat side faces of the hating chamber 18. This then allows the plurality of susceptors 42 to couple to the inner surface 36 to be held in place within the heating chamber 18 by friction.

In other embodiments, the side wall 30 can have other suitable shapes, such as a tube with an elliptical, circular, or triangular cross section. In yet further embodiments, the side wall 30 can be generally tapered towards its base 32.

In the illustrated embodiment, the base 32 of the heating chamber 18 is closed, e.g. sealed or air-tight. That is, the heating chamber 18 is cup-shaped. This can ensure that air drawn from the open first end 26 is prevented by the base 32 from flowing out of the second end 34 and is instead guided through the aerosol generating substrate 102. It can also ensure that a user inserts the aerosol generating article 100 into the heating chamber 18 an intended distance and no further.

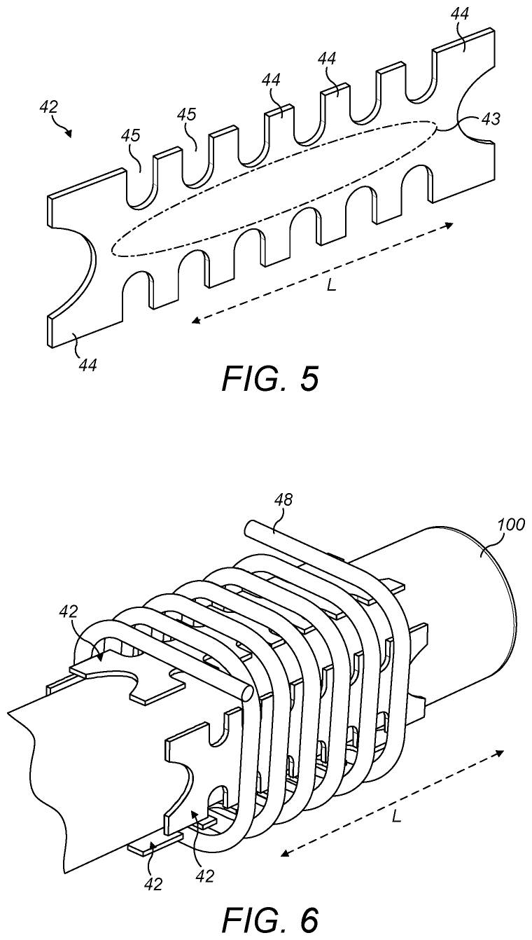

The aerosol generating device 10 comprises a plurality of inductively heatable susceptors 42 provided within the heating chamber 18. FIG. 5 shows an example susceptor 42. FIG. 6 shows a perspective view of an aerosol generating article 100 as would be held within the heating chamber 18 and between a plurality of susceptors 42, but with the heating chamber 18 ‘subtracted out’ of the diagram for ease of viewing. The susceptors 42 comprise a magnetically susceptible material which generates heat by eddy current resistance and/or by magnetic hysteresis losses when placed in a time-varying magnetic field. This allows the susceptors 42 to provide heating to an aerosol generating substrate 102 comprising, e.g., tobacco. Preferably, a material with a high magnetic susceptibility, such as carbon steel, is chosen for the susceptors 42 to maximise the efficiency with which electromagnetic energy is converted to heat. The skilled person would appreciate other magnetically susceptible materials may also be used alternatively or in addition.

Each of the susceptors 42 comprises a body 43, shown in FIG. 5 by a dashed region, and a plurality of projections 44 which extend from the body 43 at a plurality of spaced positions along the longitudinal axis (L) at opposing sides of the susceptor 42. The susceptor 42 is substantially flat, i.e. its body 43 and plurality of projections 44 occupy substantially the same spatial plane. The plurality of projections 44 form a plurality of spaces 45 between adjacent projections.

The body 43 is configured to function as a contact point between an aerosol generating article 100 and the susceptor 42 to allow heat transfer from the susceptor 42 to the aerosol generating substrate 102 by conduction. Four identical susceptors 42 are circumferentially spaced around an inner periphery of the heating chamber 18 with the longitudinal axis of the susceptors 42 aligned with the longitudinal axis of the heating chamber 18. More specifically, four of the susceptors 42 are provided abutting the four main flat internal side faces of the inner surface 36 of the side wall 30, as shown in FIGS. 3 and 4. Providing the susceptors at the inner periphery of the heating chamber 18 enables a rod shaped aerosol generating article 100 to be placed within the cavity 20 without becoming blocked by the susceptors 42. Additionally, the aerosol generating article 100 can be held in place between four susceptors 42, as shown in FIGS. 4 and 6. The plurality of susceptors 42 are positioned within the heating chamber 18 so that the body 43 of each respective susceptor 42 makes contact with the aerosol generating article 100 when held within the cavity 20. This allows each of the bodies 43 to act as both a mechanism for holding a consumable in place and as a contact point for providing efficient heating to an aerosol generating substrate 102 by conduction.

In the example embodiment of FIGS. 3 to 6, the susceptor 42 is elongate along the longitudinal axis (L) to maximise the available surface area which can make contact with the aerosol generating article 100, thus increasing the efficiency of heat transfer. It is envisaged that in other embodiments the susceptor may not be elongate along the longitudinal axis (L). Four susceptors 42 are provided to ensure even heating of the aerosol forming substrate 102 when placed within the heating chamber 18; however less or more susceptors 42 may be provided in other embodiments.

The plurality of projections 44 are configured to increase the total surface area of the susceptor 42, thereby increasing the quantity of heat inductively generated by the susceptor 42 per unit strength of time-varying magnetic field. Thus, the plurality of projections 44 can be considered to act as antennae which increase interaction with the electromagnetic field, thereby increasing the heating efficiency of the aerosol generating device 10. The plurality of projections 44 extend perpendicularly from the longitudinal axis of the body 43 along a direction parallel to both the flat internal flat side faces of the heating chamber 18 and to the induction coil 48. Thus, the plurality of projections 44 align circumferentially with the side wall 30 and the induction coil 48. It is considered that providing the plurality of projections 44 aligned circumferentially with the magnetic induction coil 48 in this way maximises the magnetic interaction between the susceptor 42 and the induction coil 48. Providing the plurality of projections 44 generally parallel to the side wall 30 makes efficient use of space within the cavity 20 and avoids the obstruction of a consumable by the plurality of projections 44. The plurality of projections 44 are provided symmetrically on two sides of the body 43 to promote even heating of the susceptor 42, though non-symmetrical shapes may also be used.

The plurality of projections 44 are provided with a spatial frequency along the longitudinal axis (L) which matches the spatial frequency of wire loops of the induction coil 48 along the same axis, i.e. the pitch of the induction coil 48. It is considered that matching these spatial frequencies increases the efficiency of the induction heating process.

In some embodiments, the plurality of spaces 45 may be used as part of a mechanism for attaching the susceptor 42 to the heating chamber 18. For example, the inner surface 36 of the side wall 30 may comprise ribs sized with respect to the plurality of spaces 45 to allow a friction coupling between the ribs and the susceptor 42.

In the example embodiment of FIGS. 3 to 6, the four susceptors 42 are provided equidistantly from a central longitudinal axis of the heating chamber 18 which is co-axial with the longitudinal axis of the magnetic induction coil 48. This ensures a homogeneous setup wherein each of the susceptors 42 are provided at an ideal distance from the magnetic induction coil 48. Additionally, this configuration promotes even heating of the aerosol forming substrate 102 from all sides, thereby avoiding undesirable combustion or overheating of the aerosol forming substrate 102.

The aerosol generating device 10 comprises an electromagnetic field generator 46 for generating an electromagnetic field. The electromagnetic field generator 46 comprises a substantially helical magnetic induction coil 48. The induction coil 48 extends helically around the heating chamber 18, and thus the induction coil 48 has the same cross sectional shape as the outer surface 38 of the heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48. The side wall 30 of the heating chamber 18 may include a coil support structure 50 formed in the outer surface 38. As best seen from FIGS. 1 and 2, the coil support structure 50 comprises a coil support groove 52 which extends helically around the outer surface 38. The induction coil 48 is positioned in the coil support groove 52 and is, thus, securely and optimally positioned with respect to the susceptors 42.

An example use of the aerosol generating device 10 will now be described.

A user displaces the sliding cover 28 from the closed position shown in FIG. 1 to the open position shown in FIG. 2. The user then inserts an aerosol generating article 100 through the open first end 26 into the heating chamber 18, so that the aerosol generating substrate 102 is received in the cavity 20 and so that the proximal end 104 of the aerosol generating article 100 is positioned at the open first end 26 of the heating chamber 18, with at least part of the mouthpiece segment 108 projecting from the open first end 36 to permit engagement by a user's lips. The aerosol generating article 100 is thereafter held in place within the cavity 20 by friction against the susceptors 42.

Upon activation of the input device by a user, the induction coil 48 is energised by the power source 22 and controller 24 which supply an alternating electrical current to the induction coil 48. The induction coil 48 in turn generates an alternating and time-varying electromagnetic field inside the heating chamber 18. This couples with the susceptors 42 and generates eddy currents and/or magnetic hysteresis losses in the susceptors 42 causing them to heat up. The plurality of projections 44 on each of the susceptors 42 increase the strength of interaction between each of the susceptors 42 and the induction coil 48, thereby converting more electromagnetic energy into heat energy. This provides a more efficient heating apparatus and aerosol generating device 10 compared to device using susceptors without the plurality of projections 44. The heat is then transferred from the susceptors 42 to the aerosol generating substrate 102 at the four contact points between the aerosol generating article 100 and the four susceptors 42 by conduction. Heat will also be transferred to the aerosol generating substrate 102 by radiation and convection within the heating chamber 18.

The heating of the aerosol generating substrate 102 can thereby be achieved without combustion or burning, and a vapour is thereby generated. The generated vapour cools and condenses to form an aerosol which can be inhaled by a user of the aerosol generating device 10 through the mouthpiece segment 108, and more particularly through the filter segment. The vaporisation of the aerosol generating substrate 102 is facilitated by the addition of air from the surrounding environment, for example through the open first end 26 of the heating chamber 18, the air being heated as it flows between the wrapper 110 of the aerosol generating article 100 and the inner surface 36 of the side wall 30. More particularly, when a user sucks on the filter segment, air is drawn into the heating chamber 18 through the open first end 26 as illustrated by the arrows (A) in FIG. 2. The air entering the heating chamber 18 flows from the open first end 26 towards the closed end 34, between the wrapper 110 and the inner surface 36 of the side wall 30. When the air reaches the closed second end 34 of the heating chamber 18, it turns through approximately 180° and enters the distal end 106 of the aerosol generating article 100. The air is then drawn through the aerosol generating article 100 as illustrated by the arrow (B) in FIG. 2, from the distal end 106 towards the proximal (mouth) end 104 along with the generated vapour.

A user can continue to inhale aerosol all the time that the aerosol generating substrate 102 is able to continue to produce a vapour, e.g. all the time that the aerosol generating substrate 102 has vaporisable components left to vaporise into a suitable vapour. The controller 24 can adjust the magnitude of the alternating electrical current passed through the induction coil 48 to ensure that the temperature of the susceptors 42, and in turn the temperature of the aerosol generating substrate 102, does not exceed a threshold level. Specifically, at a particular temperature, which depends on the constitution of the aerosol generating substrate 102, the aerosol generating substrate 102 will begin to burn. This is not a desirable effect and temperatures above and at this temperature are avoided.

To assist with this, in some examples the aerosol generating device 10 is provided with a temperature sensor (not shown). The controller 24 is arranged to receive an indication of the temperature of the aerosol generating substrate 102 from the temperature sensor and to use the temperature indication to control the magnitude of the alternating electrical current supplied to the induction coil 48.

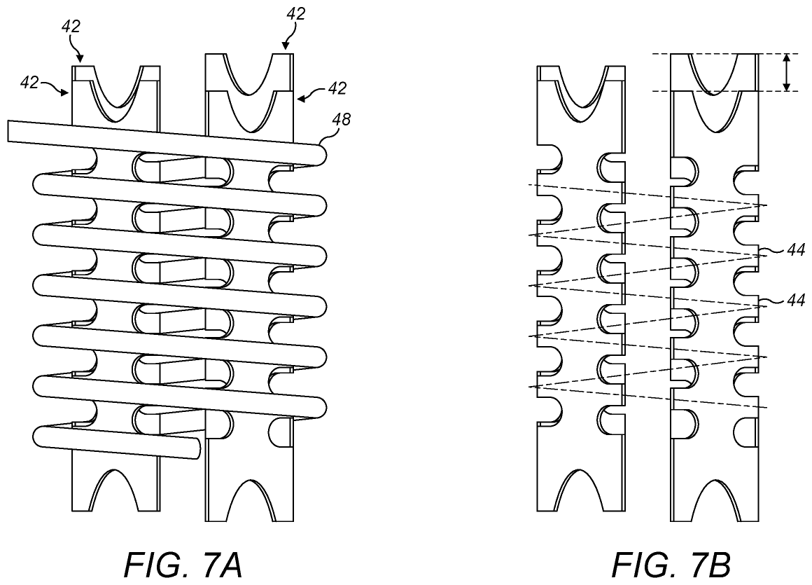

FIGS. 7A and 7B show an alternative configuration of the susceptors 42 within the heating chamber 18. As described previously, the plurality of projections 44 are provided with a spatial frequency along the longitudinal axis (L) which matches the spatial frequency of the induction coil 48. The plurality of projections 44 can also be provided longitudinally offset so that successive projections circumferentially align with successive loops of the induction coil 48. One way of achieving this, demonstrated by the reference arrows in FIG. 7B, is to provide four identical susceptors 42 which are positioned at longitudinally offset positions within the heating chamber 18. As shown in FIG. 7A and by the dashed helical line in FIG. 7B, this allows each of the susceptors 42 to have their respective pluralities of projections 44 aligned with the substantially helical induction coil 48. Another way of achieving this configuration (not shown) is to provide differently shaped susceptors which are not longitudinally offset. It is considered that aligning the induction coil and the plurality of projections 44 in this way can provide a further optimisation of the induction heating process, creating a yet more efficient aerosol generating device 10.

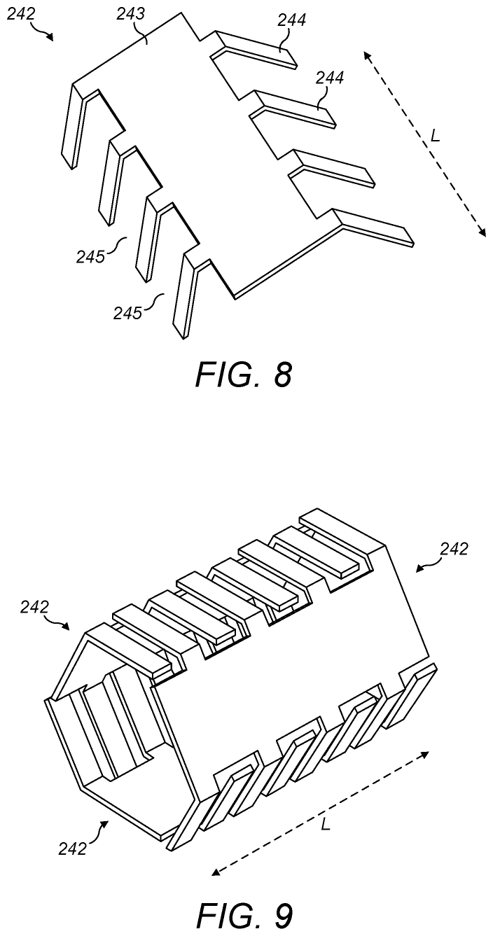

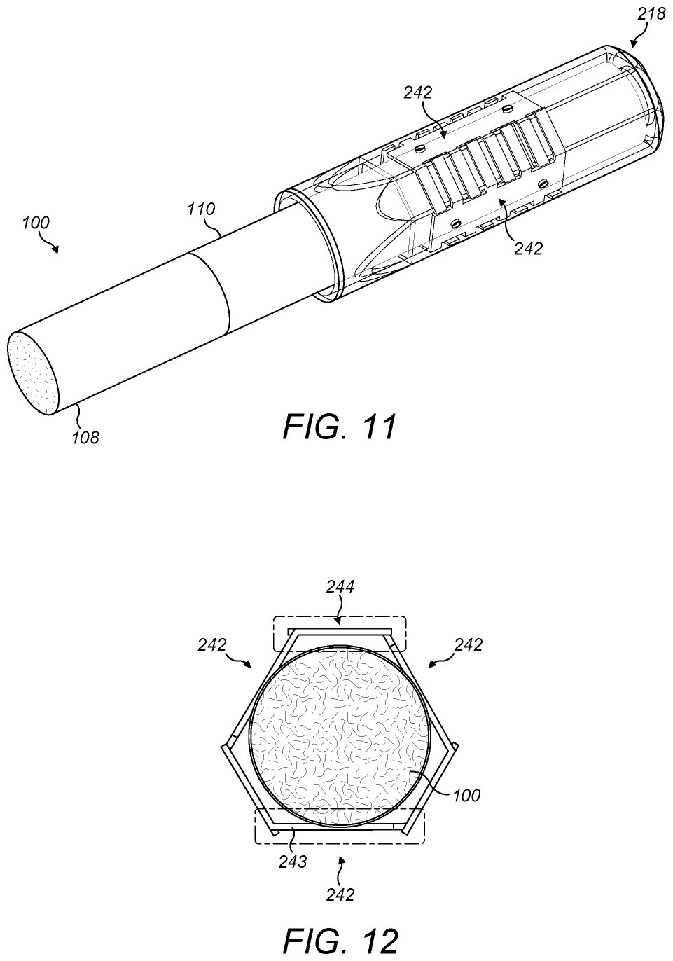

FIGS. 8 to 12 show an alternatively configured susceptor 242 and corresponding heating chamber 218, according to a second embodiment of the invention. The heating chamber 218 and three of the susceptors 242 can be utilised with the aerosol generating device 10 of FIGS. 1 and 2 in the same way as with the susceptors 42 and the heating chamber 18 to provide an efficient heating apparatus for the aerosol generating device 10.

FIG. 8 illustrates the susceptor 242, which comprises a body 243 that is also elongate along the longitudinal axis (L). A plurality of projections 244 are provided at evenly spaced positions along the longitudinal axis of the body 243. Like the plurality of projections 44, the plurality of projections 244 may be provided with a spatial frequency matching a spatial frequency of wire loops of the induction coil 48 and aligned therewith within the heating chamber 218. However, the plurality of projections 243 differ from the plurality of projections 44 in that they extend from the body 243 at an angle with respect to the normal of the substantially flat body 243. In one example embodiment, the plurality of projections 244 extend from the body 243 to form an internal angle of approximately 120 degrees with the body 243. As shown in FIG. 9, this enables three of the susceptor 242 to be arranged into a structure with an irregularly hexagonal cross section. The plurality of projections 244 are also provided on opposing sides of the susceptor 242, but with the projections on one side offset longitudinally from those on the other side. This allows two adjacent susceptors 242 to be arranged with their respective pluralities of projections 244 interposing, or interdigitating, as seen most clearly in FIG. 9.

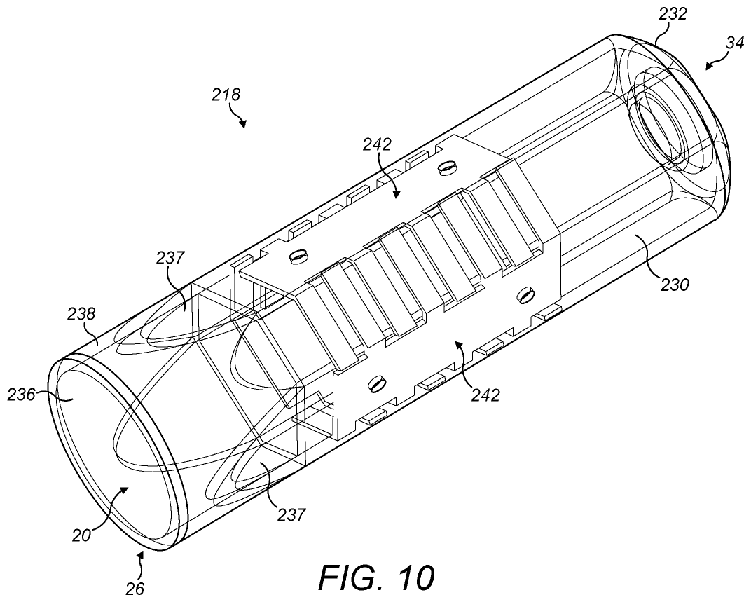

FIG. 10 illustrates the heating chamber 218. The heating chamber 218 comprises a side wall 230 with a corresponding inner surface 236; outer surface 238; base 232; and tapered portions 237. The heating chamber 218 is also substantially cylindrical, but differs from the heating chamber 18 in that the side wall 230 has a substantially hexagonal cross section. This enables three of the susceptors 242 to be positioned within the heating chamber 218 in the interposing configuration of FIG. 9. The susceptors 242 can be held in place by a friction fit with the inner surface 236. The susceptors 244 may be provided with a longitudinal length less than or equal to the entire (internal) longitudinal length of the heating chamber 218.

In this example embodiment, the induction coil 48 is also provided wrapped about the side wall 230. Consequently, in this embodiment the induction coil 48 has a substantially hexagonal cross section. The plurality of projections 242 are positioned within the heating chamber 218, and angled with respect to the body 243, to align circumferentially with the induction coil 48 and the side wall 230. This provides a particularly efficient inductive heating configuration because the plurality of projections 242 extend along a direction aligned with the circumference of the induction coil 48. Furthermore, three susceptors 242 can be positioned interposing to form a cylindrical structure. Consequently, the susceptors 242 can, together, extend around the full circumference of the heating chamber 218, enabling a maximisation of the total surface area of the susceptors 242. This maximises the degree of interaction with the induction coil 48 to provide a more efficient heating apparatus.

In the example embodiment of FIGS. 8 to 12, the heating chamber 218 has three wider flat internal side faces and three narrower flat internal side faces to form an irregular hexagon shape. As illustrated in FIG. 12 by circled areas, this enables an aerosol generating article 100 to be frictionally held by the respective bodies 243 of three susceptors 242, which sit against the wider flat internal side faces. The interposing plurality of projections 244 align with the narrower flat internal side faces so that contact between the aerosol generating article 100 and the plurality of projections 244 is avoided. This avoids the aerosol generating article 100 catching on the projections during insertion.

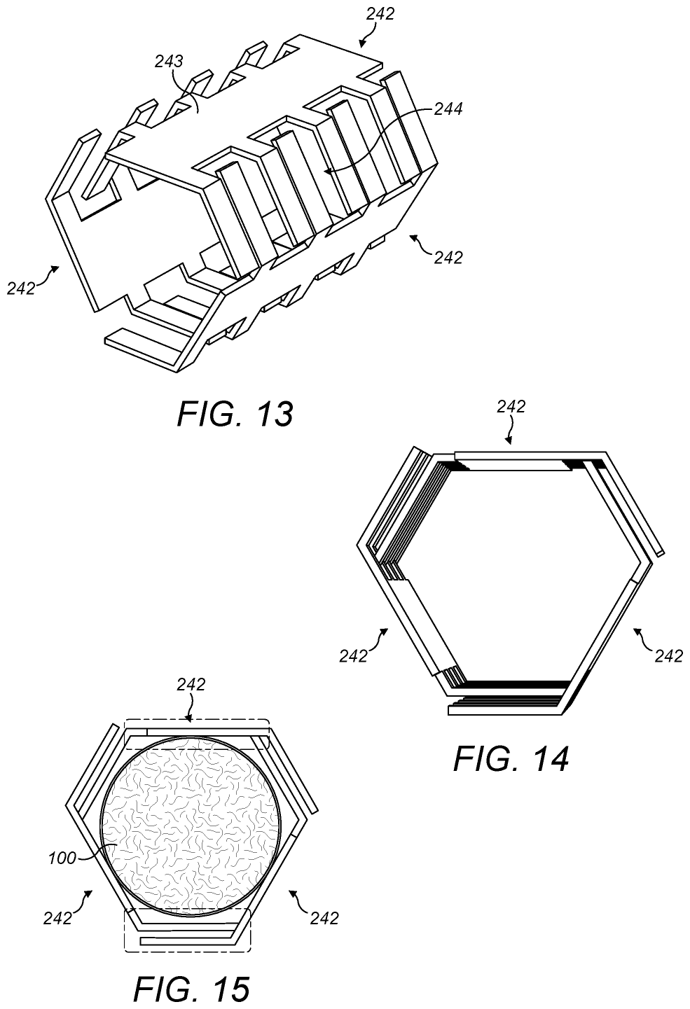

In the configuration of FIGS. 8 to 12, the three susceptors 242 are arranged at a constant radial distance from a central longitudinal axis of the heating chamber 218. In other words, arranged at a constant radial distance to the central axis which runs through the geometric centre of a cross section of the heating chamber 218. The susceptors 242 are also evenly spaced circumferentially so that the plurality of projections 244 corresponding to each susceptor 242 are situated at a constant radial distance from the central axis. This can be seen most clearly in FIG. 12 which shows a cross sectional view of the susceptors 242 and in contrast to the alternative configuration of FIGS. 13 to 15, as described below. Providing the susceptors 242 radially and circumferentially aligned in this way can make the aerosol generating device 10 simpler to manufacture.

FIGS. 13 to 14 illustrate an alternative configuration in which the susceptors 242 can be arranged within the heating chamber 218. In this configuration, three susceptors 242 are tangentially shifted so that each susceptor 242 has some projections at a first, smaller radial distance from the central axis of the heating chamber 218 and some projections at a second, larger radial distance from the central axis, as best seen from FIG. 15. This configuration can increase the strength of interaction with the induction coil 48 because some projections are provided at a smaller radial distance to the induction coil 48. Thus, a more efficient aerosol generating device 10 may be provided. In this configuration, the aerosol generating article can still be held between the bodies 243 of the susceptors 242, as illustrated by the highlighted region of the cross section shown in FIG. 15.

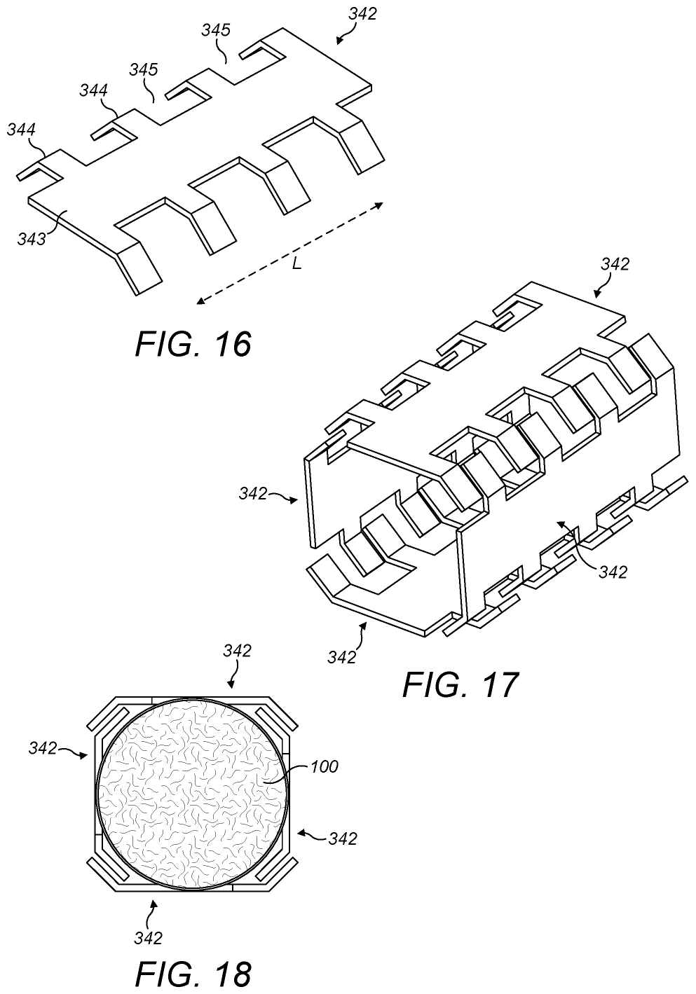

FIGS. 16 to 19 show an alternatively configured susceptor 342 and corresponding heating chamber 318, according to a third embodiment of the invention. The heating chamber 318 and susceptors 342 can be utilised with the aerosol generating device 10 of FIGS. 1 and 2 in the same way as with the susceptors 42 and the heating chamber 18 to provide an efficient heating apparatus for the aerosol generating device 10.

FIG. 16 illustrates the susceptor 342, which comprises a body 343 that is also elongate along the longitudinal axis (L). A plurality of projections 344 are provided at evenly spaced positions along the longitudinal axis of the body 343, leaving a plurality of spaces 345 between adjacent projections. Like the plurality of projections 44, the plurality of projections 344 may be provided with a spatial frequency matching a spatial frequency of wire loops of the induction coil 48 and aligned therewith within the heating chamber 318. However, the plurality of projections 344 differ from the plurality of projections 44 in that they extend further from the body 343 and comprise a kink with respect to the normal of the substantially flat body 343. As shown in FIG. 17, this enables four of the susceptor 342 to be arranged into a cylindrical structure with a substantially square cross section. The plurality of projections 344 are also provided on opposing sides of the susceptor 342, but with the projections on one side offset longitudinally from those on the other side. This allows two adjacent susceptors 342 to be arranged with their respective pluralities of projections 344 interposing, or interdigitating.

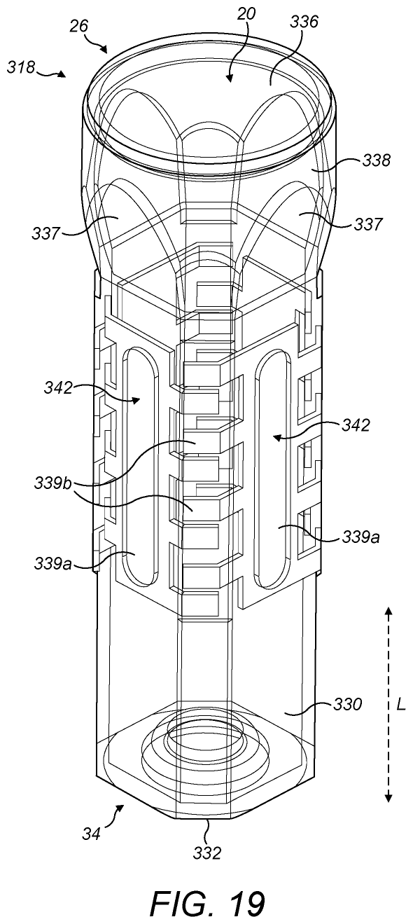

FIG. 19 illustrates the heating chamber 318. The heating chamber 318 comprises a side wall 330 with a corresponding inner surface 336; outer surface 338; base 332; and tapered portions 337. The heating chamber 318 is similar to the heating chamber 18 and is substantially cylindrical with a bevelled square cross section. This enables four of the susceptors 342 to be positioned within the heating chamber 318 in the interposing configuration of FIG. 17. The susceptors 342 can be held in place by a friction fit with the inner surface 336.

Additionally, the heating chamber 318 comprises a plurality of windows 339a, 339b configured to reduce the transfer of heat from the susceptors 342 to the side wall 330. In particular, the plurality of windows 339a, 339b reduce surface area of the side wall 330 in contact with the susceptors 342 so that less heat is transferred by conduction and radiation. Advantageously, this prevents unwanted heating of the heating chamber 318, and can also reduce the concentration of particulate matter which may reach the aerosol as a result of heating the heating chamber 318, thereby increasing the quality of the aerosol. Some of the plurality of windows 339a are provided on the main faces of the side wall 330 to reduce the surface area in contact with the bodies 343 of the susceptors 342. Some of the plurality of windows 339b are provided on the bevelled faces of the side wall 330 to reduce the surface area in contact with the plurality of projections 344 of the susceptors 342. The plurality of windows 339a, 339b included in the heating chamber 318 may equally be provided in the heating chamber 18 or the heating chamber 218 and positioned to align with the positioning of the susceptors provided in those heating chambers.

In the example embodiment of FIGS. 16 to 19, the induction coil 48 is also provided wrapped about the side wall 330. Consequently, the induction coil 48 has a substantially square cross section, as in the case of the embodiment. The plurality of projections 342 are positioned within the heating chamber 318, and angled with respect to the body 343, to align circumferentially with the induction coil 48 and the side wall 330. This provides a particularly efficient inductive heating configuration because the plurality of projections 342 extend along a direction or contour aligned with the circumference of the induction coil 48. Furthermore, the susceptors 342 can be positioned interposing to form a cylindrical structure with a substantially square cross section. Consequently, the susceptors 342 can extend around the full circumference of the substantially square heating chamber 318, enabling a maximisation of the total surface area of the susceptors 342. This maximises the strength of interaction with the induction coil 48 to provide a more efficient heating apparatus.

FIG. 18 shows an aerosol generating article 100 held in place by friction with four adjacent susceptors 342. Two susceptors 342 (i.e. the top and bottom susceptors 342 in FIG. 18) are arranged at a third, larger radial distance from a central longitudinal axis of the heating chamber 318. Two of the susceptors 342 (i.e. the left and right susceptors 342 in FIG. 18) are arranged at a fourth, smaller radial distance from the central axis. This configuration provides the advantage that the susceptors 342 can be freely longitudinally offset with respect to one another without obstruction from adjacent susceptors 342. This allows the plurality of projections 344 to be aligned with successive wire loops of the induction coil 48 analogously to FIGS. 7A and 7B, thus providing a more efficient heating apparatus. Additionally, some of the plurality of projections 344 can be provided closer to the induction coil 48, which can further increase the strength of interaction between the susceptors 343 and the induction coil 48.

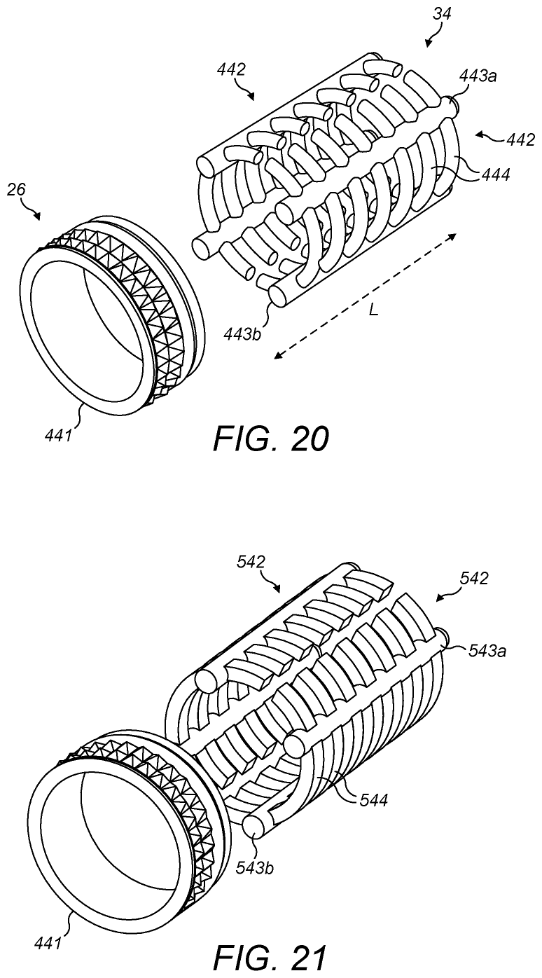

FIG. 20 shows a susceptor 442 according to a fourth embodiment of the invention. One or more of the susceptor 442 can be provided within a cylindrical heating chamber and incorporated into the aerosol generating device 10 of FIGS. 1 and 2, functioning in the same way as previously described to provide a more efficient heating apparatus.

The susceptor 442 comprises two cylindrical susceptor sticks 443a, 443b in place of the body 43 of the first embodiment of the invention. The susceptor sticks 443a, 443b are elongate along the longitudinal axis and connected by a plurality of projections 444 which extend from and through each of the susceptor sticks 443a, 443b. The plurality of projections 444 extend from the susceptor sticks 443a, 443b at evenly spaced intervals along the longitudinal axis (L) with a spatial frequency which matches the spatial frequency of the wire loops of the induction coil 48 along the same axis. The plurality of projections 444 have a cylindrical shape configured to circumferentially align with the induction coil 48. The plurality of projections circumferentially extend from the susceptor sticks 443a, 443b to form an approximate half-torus within a cylindrical heating chamber (not shown). This allows two of the susceptors 442 to be provided within a cylindrical heating chamber in the configuration shown in FIG. 20. In such a configuration the plurality of projections 444 extend around nearly the full circumference of the heating chamber, similarly to previous embodiments, to provide a more efficient heating apparatus.

Unlike the body 43, the susceptor sticks 443a, 443b have a cylindrical shape which extends towards the centre of the heating chamber. This allows an aerosol generating article 100 to be held by friction between the susceptor sticks 443a, 443b. The susceptor sticks 443a, 443b can extend further into the heating chamber than, for example, the body 42, and can cause a greater compression of the aerosol generating article 100 while it is held within the cavity 20. Consequently, an increased surface area can be in contact between the susceptor sticks 443a, 443b and the aerosol generating article 100, thereby increasing the heat transfer rate by conduction from the susceptors 442 to the aerosol generating article 100. Thus, the susceptor sticks 443a, 443b can yet further improve the efficiency of the aerosol generating device 10.

The plurality of projections 444 are configured to encounter the susceptor sticks 443a, 443b perpendicularly to the longitudinal axis. In some configurations, this can provide an optimal interaction with the induction coil 48. In some embodiments, the projections may not meet the susceptor sticks 443a, 443b perpendicularly, as is described in more detail below with respect to further embodiments.

The susceptors 442 can be provided attached to a handle 441 configured to be removable by a user from the heating chamber. The handle 441 may include an anti-slip surface. In FIGS. 20 and 21, the handle 441 is shown in an exploded view from the susceptors 442 for clarity. The handle 441 enables a user to remove the susceptors 442 from the heating chamber so that the heating chamber can be cleaned of stray aerosol generating substrate 102 or other particulate matter. Thus, the provision of a handle 441 can lead to an improvement of the quality of the aerosol. It is envisaged that the heating chambers of the previous and/or later embodiments may also be provided with a handle enabling the removal of the susceptors therein.

FIG. 21 shows a susceptor 542 according to a fifth embodiment of the invention. The susceptor 542 comprises two cylindrical susceptor sticks 543a, 543b and a plurality of projections 544 equivalent to those on the previous susceptor 442. The susceptor 542 is identical to the susceptor 442 shown in FIG. 20, except that the corresponding plurality of projections 544 have a rectangular cross section instead of a circular cross section. In some configurations, this can provide an improved interaction with the induction coil 48 to provide a more efficient heating apparatus for the aerosol generating device 10.

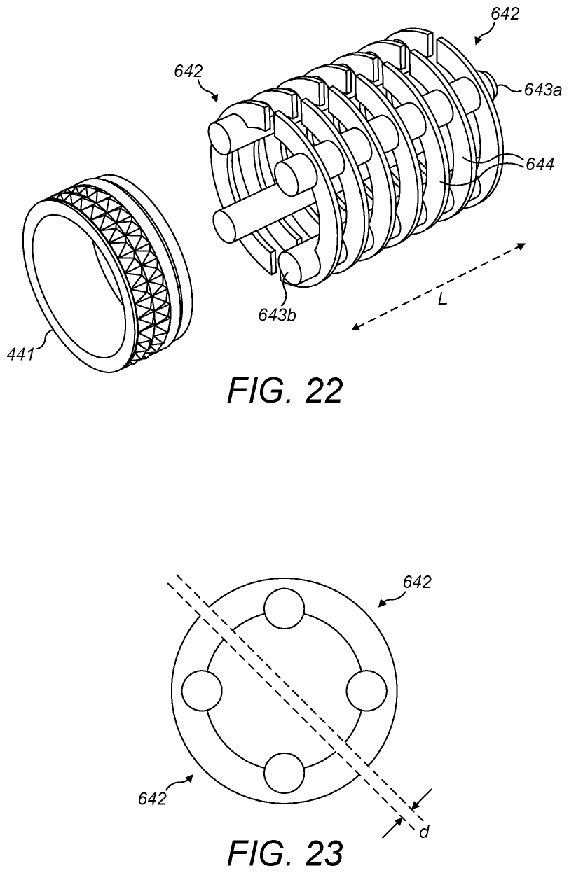

FIG. 22 shows a susceptor 642 according to a sixth embodiment of the invention. Equivalent to the susceptor 442, the susceptor 542 comprises two cylindrical susceptor sticks 643a, 643b and a plurality of projections 644. The susceptor 642 is identical to the susceptor 442 shown in FIG. 20, except that the corresponding plurality of projections 644 are substantially flat in a plane perpendicular to the longitudinal axis (L). In some configurations, this can provide an improved interaction with the induction coil 48 to provide a more efficient heating apparatus for the aerosol generating device 10.

FIG. 23 shows an overhead view of two susceptors 642 arranged adjacently with a separation d. The separation d may be chosen in a given implementation to maximise the interaction strength between the susceptors 642 and the induction coil 48, to further improve the efficiency of the aerosol generating device 10. In some embodiments, d may take values of a few millimetres, or ten millimetres. In other embodiments, d may equal approximately or exactly zero. The equivalent separation distance between adjacent susceptors in the fourth or fifth embodiments of the invention may also be chosen for optimal heating efficiency.

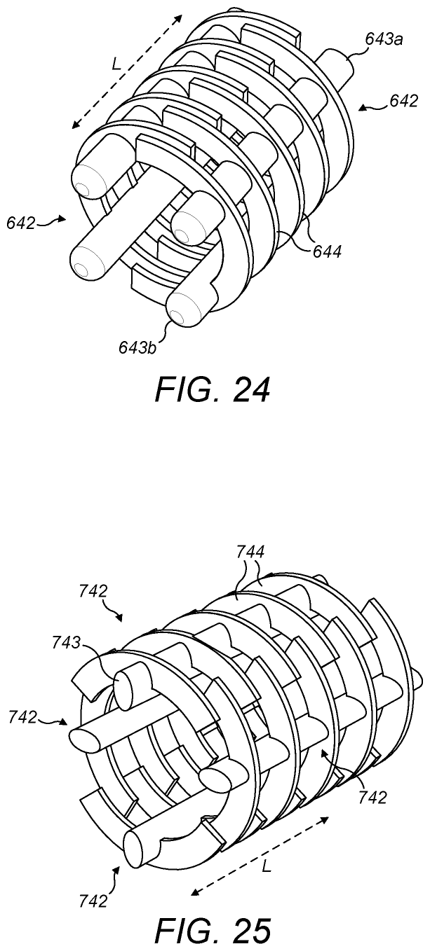

FIG. 24 shows an alternative configuration wherein two adjacent susceptors 642 are provided with longitudinally offset projections. This enables the susceptors 642 to be provided closer together with their respective projections interdigitating. This can enable the plurality of projections 644 to extend further around the circumference of the heating chamber, thereby increasing the total surface area, or volume, of the susceptors 642 which interacts with the induction coil 48. Consequently, the interaction between the susceptors 642 and the induction coil 48 can be improved to provide an even more efficient heating apparatus.

FIG. 25 illustrates a susceptor 742 according to a seventh embodiment of the invention. The susceptor 742 comprises a (single) susceptor stick 743 in place of the two susceptor sticks 443a, 443b of the susceptor 442. The susceptor stick 743 is cylindrical with an oblate circular cross section which is oblate towards the central axis of the cavity 20. This enables the susceptor stick 743 to provide a greater compression on an aerosol generating article held in place within the cavity 20 by the susceptors 742. The susceptor 742 comprises a plurality of projections 744 which are identical to the flat plurality of projections 642, except that they extend from either side of the susceptor stick 743 to a lesser degree. This enables four adjacent susceptors 742 to be arranged into the cylindrical configuration shown in FIG. 25 so that they can be positioned within a cylindrical heating chamber to provide even heating to an aerosol generating article 100. The susceptors 742 can be provided longitudinally offset with respect to one another and positioned so that the plurality of projections of adjacent susceptors 742 overlap. This enables the plurality of projections 744 to be positioned in alignment with successive wire loops of the induction coil 48. Utilising the susceptors 742 in this way can provide an improved interaction with the induction coil 48 to provide a more efficient heating apparatus for the aerosol generating device 10.

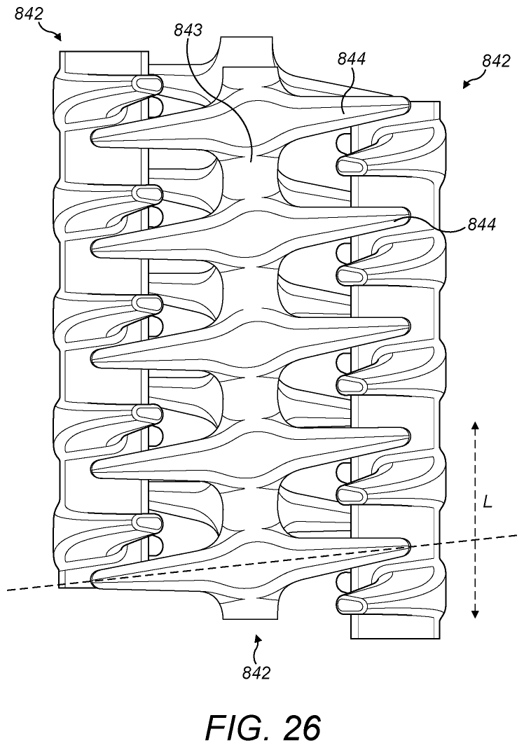

FIGS. 26 to 28 show a susceptor 842 according to an eighth embodiment of the invention. The susceptor 842 comprises a (single) susceptor stick 843 which is oblate (see FIG. 28) in the same way as the susceptor stick 743 to provide a better contact surface with a consumable.

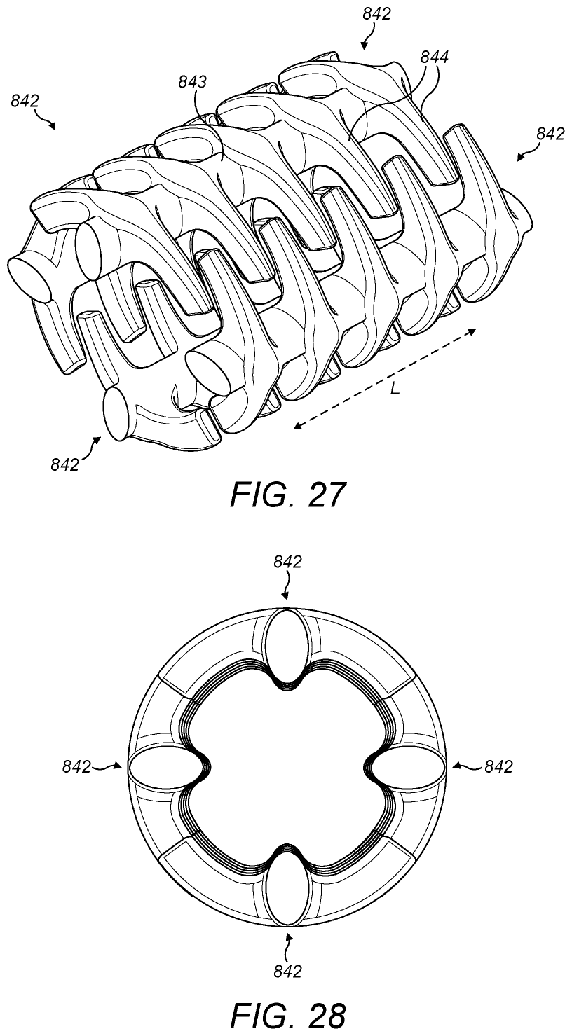

The susceptor 742 also comprises a plurality of projections 844 configured to extend circumferentially around a cylindrical heating chamber to align with successive wire loops of an induction coil 48 wrapped about the heating chamber. As best seen from the reference line in FIG. 26, the plurality of projections 844 extend from the susceptor stick 843 in a direction with a non-zero component along the longitudinal direction (L). Advantageously, this enables the plurality of projections 844 to extend along a direction or contour which more closely aligns with the helical contour of the induction coil 48. This can result in a greater magnetic interaction between the susceptors 842 and the induction coil 48 to provide a more efficient aerosol generating device 10. Additionally, configuring the plurality of projections 844 in this way enables two or more adjacent susceptors 842 to be provided with their respective projections interposing, or interdigitating. The plurality of projections 844 may or may not be provided with a spatial frequency along the longitudinal axis (L) which matches the spatial frequency of wire loops of the induction coil 48. As best seen from FIGS. 27 and 28, the susceptors 842 may be provided offset longitudinally with respect to one another.

The susceptor 842 may be manufactured by a casting method. This may increase the ease of manufacturing the aerosol generating device 10. Additionally, utilising a casting method enables irregular susceptor shapes to be produced easily using a mould. Previously described embodiments of the invention may also be manufactured using a casting method.

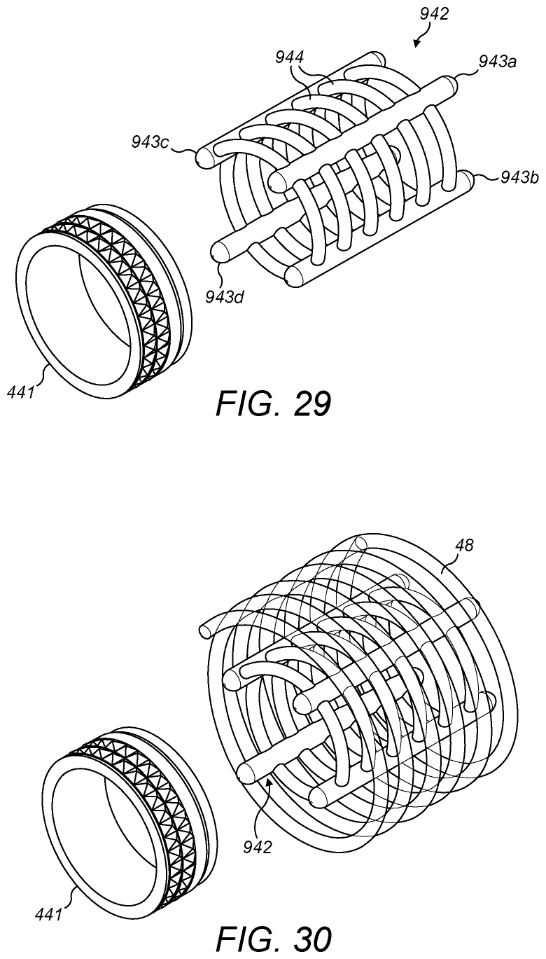

FIGS. 29 and 30 illustrate a susceptor 942 according to a ninth embodiment of the invention. The susceptor 942 comprises four cylindrical susceptor sticks 943a, 943b, 943c, 943d which may be attached to a handle 441 for removal from the heating chamber. The susceptor sticks 943a, 943b, 943c, 943d are elongate along the longitudinal axis and connected by a plurality of projections 944 which extend helically from and through each of the susceptor sticks 943a, 943b, 943c, 943d to form an integrally whole piece. Thus, a single susceptor 942 can be provided in a heating chamber to secure and heat an aerosol generating article 100 evenly, and the aerosol generating device 10 may thus be simpler to manufacture.

The plurality of projections 944 extend from the susceptor sticks 943a, 943b, 943c, 943d at evenly spaced intervals along the longitudinal axis (L). The plurality of projections 944 are configured to extend helically around the circumference of a heating chamber to maximise the circumferential alignment with the induction coil 48, as shown in FIG. 30. As described in relation to previous embodiments, this can further improve the efficiency of the heating apparatus.

1. A heating apparatus for an aerosol generating device, comprising:
a heating chamber configured to receive an aerosol forming substrate; and
a first susceptor configured to provide heating by magnetic induction provided at a periphery of the heating chamber;
wherein the first susceptor comprises:
a first body having a longitudinal axis; and
a first plurality of projections which extend from the first body at a plurality of spaced positions along the longitudinal axis to form spaces between adjacent projections.

2. The heating apparatus of claim 1, further comprising a second susceptor configured to provide heating by magnetic induction comprising a second body having a longitudinal axis coaxial with the longitudinal axis of the first body, and a second plurality of projections which extend from the second body at a plurality of spaced positions along the longitudinal axis to form spaces between adjacent projections, wherein the first susceptor and the second susceptor are provided at spaced positions about a periphery of the heating chamber.

3. The heating apparatus of claim 2, wherein the second susceptor is positioned relative to the first susceptor such that the projections of the second susceptor interpose between the projections of the first susceptor.

4. The heating apparatus of claim 2, wherein the first plurality of projections are provided at a first radial distance from a central longitudinal axis of the heating chamber and the second plurality of projections are provided at a second radial distance from the central longitudinal axis of the heating chamber which is different to the first radial distance.

5. The heating apparatus of claim 2, wherein the first plurality of projections are provided at a first radial distance from a central longitudinal axis of the heating chamber and the second plurality of projections are provided at a second radial distance from the central longitudinal axis of the heating chamber which is equal to the first radial distance.

6. The heating apparatus of claim 2, wherein the first plurality of projections and the second plurality of projections extend from the first body and the second body, respectively, and circumferentially around the heating chamber.

7. The heating apparatus of claim 2, further comprising a magnetic induction coil of an electromagnetic field generator configured to inductively heat the first susceptor and/or the second susceptor, wherein the magnetic induction coil is provided at least partially surrounding the heating chamber, and wherein the first and the second plurality of projections extend from the first body and the second body, respectively, to align circumferentially with the magnetic induction coil.

8. The heating apparatus of claim 7, wherein the first plurality of projections and/or the second plurality of projections are provided with a spatial frequency which matches the spatial frequency along a longitudinal axis of wire loops of the magnetic induction coil.

9. The heating apparatus of claim 7, wherein the first and the second plurality of projections are aligned with successive wire loops of the magnetic induction coil.

10. The heating apparatus of claim 2, wherein the heating chamber, the first body, and/or the second body are elongate along the longitudinal axis.

11. The heating apparatus of claim 1, wherein the first susceptor comprises a third body which is connected to the first body by the first plurality of projections, wherein the first plurality of projections extend from the third body at a plurality of spaced positions along the longitudinal axis to form spaces between adjacent projections.

12. The heating apparatus of claim 1, wherein the heating chamber comprises walls which form a tubular structure with a plurality of flat internal side faces.

13. The heating apparatus of claim 12, wherein the first body and the first plurality of projections have a shape and a position within the heating chamber in alignment with the flat internal side faces of the heating chamber.

14. The heating apparatus of claim 13, wherein the shape of the first body and the first plurality of projections enables the first susceptor to couple to the flat internal side faces of the heating chamber.

15. The heating apparatus of claim 1, wherein a wall of the heating chamber comprises a window configured to reduce surface area of the wall in contact with a susceptor to reduce a transfer of heat from the susceptor to the wall.
